(19) United States
(12) Patent Application Publication
(10) Pub. No.: US 2018/0029405 A1
(43) Pub. Date: Feb. 1, 2018

(54) NOBLE GLASS GLOBE WRITING IMPLEMENT

(71) Applicant: Stephen Thomas Feys, Mount Prospect, IL (US)

(72) Inventor: Stephen Thomas Feys, Mount Prospect, IL (US)

(21) Appl. No.: 15/223,169

(22) Filed: Jul. 29, 2016

(51) Int. Cl. B43K 29/10

(52) U.S. Cl. CPC B43K 29/10

(57) ABSTRACT

A writing implement with a high voltage circuit and an evacuated noble glass globe attached that responds to human touch is disclosed. The apparatus utilizes a mini high voltage circuit and mini globe to produce the plasma.

### BACKGROUND OF THE INVENTION

The present invention relates to writing implements and, more particularly, to a writing implement with an entertainment article attached thereto.

Noble gas globes have long provided a fascinating and intriguing form of entertainment that has sparked the imagination of many users. Writing can often lead to periods of time where the author is in need of a creative spark. Often they are left twirling or chewing on the end of their writing implement in search of an inspirational thought or idea.

As can be seen, there is a need for a writing implement that can provide an author with an entertaining outlet to spark an inspirational or imaginative thought or idea.

### SUMMARY OF THE INVENTION

In one aspect of the present invention, a writing implement is provided which includes: a lower body containing a retractable writing tip extensible from a first end of the lower body; an upper body having a bottom end attached to a second end of the lower body, the upper body containing a high voltage circuit; and a noble gas globe containing at least one noble gas, operatively connected to a top end of the upper body, the noble gas globe is configured to produce a plasma discharge responsive to a user's touching of the noble gas globe. The writing implement may also include a low voltage power source operatively connected to the high voltage circuit. The high voltage circuit is configured to convert an output of the low voltage power source to a high voltage output. A switch may extend through an outer sidewall of the upper body and is operable to selectably connect the low voltage power source to the high voltage circuit.

In some embodiments, the writing tip is in communication with an ink cartridge carrying a volume of ink. In other embodiments, the noble gas globe contains a plurality of noble gasses. In other aspects of the invention, the high voltage circuit includes: an oscillator operatively connected to a flyback transformer.

These and other features, aspects and advantages of the present invention will become better understood with reference to the following drawings, description and claims.

### BRIEF DESCRIPTION OF THE DRAWINGS

FIG. 1 is a perspective view of an embodiment of the writing implement, shown in use.

FIG. 2 is a perspective view of the writing implement.

FIG. 3 is an exploded view of the writing implement.

FIG. 4 is a section view of the writing implement, taken along line 4-4 in FIG. 2, with components simplified for clarity.

FIG. 5 is an electronic schematic of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a battery powered mini high voltage circuit that drives a globe containing various noble gases in a vacuum which ionizes the atoms and produces plasma responsive to a user's touching of the globe.

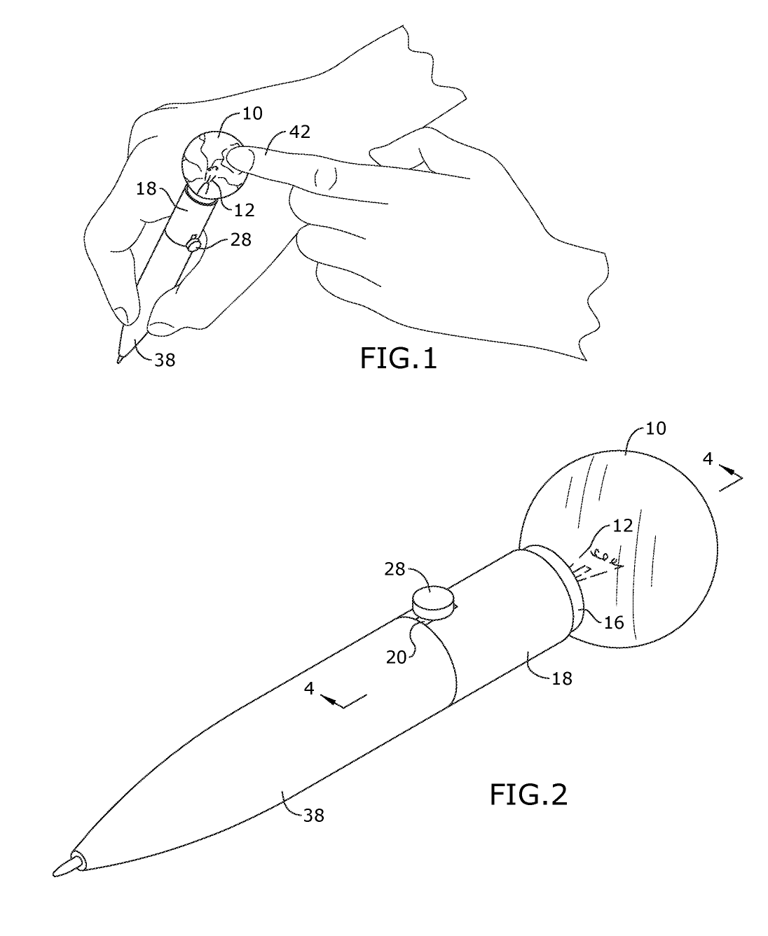

Referring now to FIGS. 1 and 2, the writing implement of the present invention includes an evacuated gas globe 10 containing a volume of a noble gas 40 under pressure. The globe 10 contains a filament 12 for applying an excitation voltage to the noble gas 40 contained within the globe 10. The globe 10 is attached to an upper body 18 of the writing implement at a top end thereof. The upper body 18 is operatively coupled to a lower body 38. When placed in an operative state via a switch 28, the noble gas globe 10 produces a plasma arc between the filament and an interior surface of the globe 10 responsive to the touch of a user's finger 42 on an exterior surface of the globe 10. A globe seat 16 carried in the top end of the upper body 18 provides a mating surface for the outer surface of the globe 10 and the upper body 18.

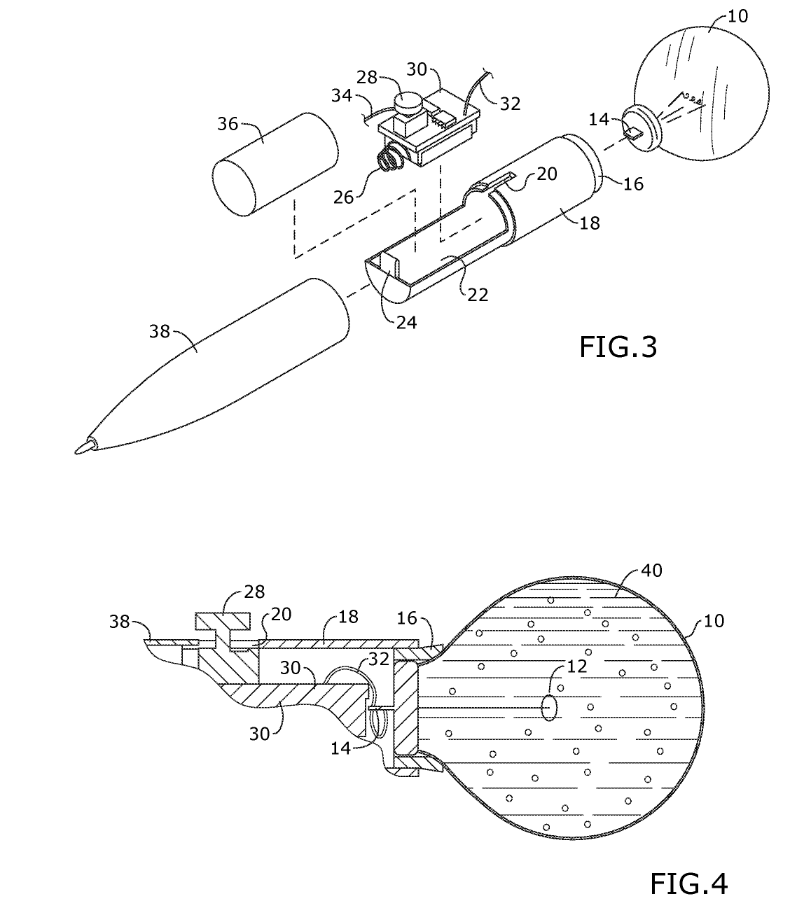

As seen in reference to FIGS. 3 and 4, the upper body 18 has a cavity defined therein to carry a circuit assembly 30 and a low voltage power source 36, such as a battery. The circuit assembly 30 is carried on a cartridge that is received within a top end of the cavity. A first conductor 32 is connected between an output of the circuit assembly 30 and a contactor 14 at a base of the globe 10. A second conductor 34 attaches a first battery contact 24 with the switch 28. A battery spring 26 may be attached to the cartridge of the circuit assembly 30 to provide a second battery contact. As will be appreciated, the configuration of the first battery contact 24 and the battery spring 26 may also be reversed so that reception of the battery 36 between the contact 24 and spring 26 to power the circuit assembly.

In further reference to FIGS. 3 and 4, the switch may be extended to an exterior surface of the upper body 18, for example via a slot 20 formed at an intermediate portion of the upper body 18. A lower portion of the upper body 18 is provided with a removable battery cover to permit replacement of the battery 36 once it has been depleted.

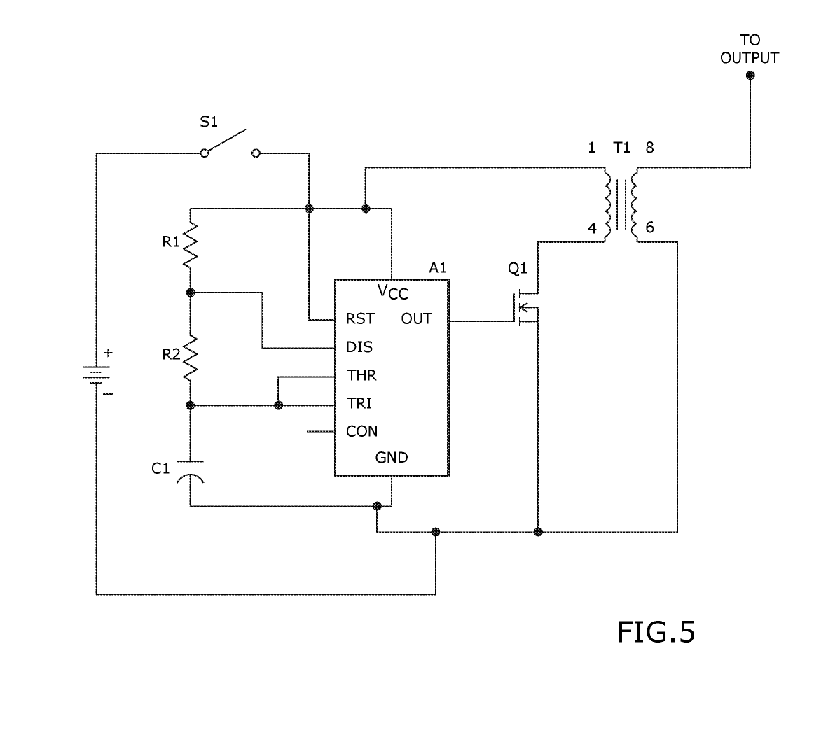

As seen in reference to FIG. 5, the circuit assembly 30 utilizes a battery 36 driven micro timer A1 that creates pulsed DC voltage that toggles an EMOSFET gate. The micro timer should not draw excessive current which can drain the battery 36 and should also be selected operate at a resonant frequency of the flyback transformer T1 to produce a maximum amplitude. When pulsed the drain and source conduct drawing current that passes through a primary coil of a flyback transformer T1. One lead 8 of the high voltage secondary coil is connected to the lead 32 that connects to the contactor 14 that enters the globe 10 to charge filament 12. The other lead 6 on the secondary coil gets connected to a ground. The globe 10 contains at least one noble gas 40 at an evacuated pressure which when excited by the high voltage circuit 30 creates plasma in the form of visible light arc that responds to human touch. The circuit can be altered to operate at different voltages, frequencies and draw different amounts of current.

The globe 10 may be formed by attaching a single tube that connects to at least one of various pressurized noble gas tank. The sealed globe 10 with a lead 14 penetrating the seal wall, a vacuum gauge, and vacuum pump. The globe 10 should be evacuated so substantially no atmosphere exists inside the globe. Then a noble gas 40 is introduced into the globe 10. The globe should be evacuated again and refilled to ensure a substantially pure noble gas 40 environment exists within the globe 10 and the fill tubing.

The high voltage circuit 30 inside the upper body 18 is electronically connected to the globe lead 32 and turned on. Place the globe 10 and writing implement in hand. A valve is used to slowly open the connection between the globe 10 and the vacuum pump. When arcs of electrons are visibly seen interacting with the user's hand the globe 10 can be pinched off to seal the globe 10 and removed from the charging system. The vacuum gauge in the system is used to record what the pressure is at the desired result. Any noble gas can be used or mixed and each has a different reaction at different pressures.

The custom pen body may be created using a 3D printer and 3D software to create the lower body 38, the battery compartment 22, high voltage circuit 30 and a globe seat 16 on top of the upper body 18 for attachment of the globe 10.

After a battery is inserted. The writing utensil has a simple switch that needs to be actuated to activate the circuit and globe. The user can then interact with the plasma in the form of electron arcs inside the globe by touching the outer glass. When finished turn switch off.

The lower body 38 contains a writing media and a media extension mechanism. The writing media may include an ink cartridge, a pencil lead, a marker, or the like.

It should be understood, of course, that the foregoing relates to exemplary embodiments of the invention and that modifications may be made without departing from the spirit and scope of the invention as set forth in the following claims.

What is claimed is:

1. A writing implement, comprising:
a lower body containing a retractable writing tip extensible from a first end of the lower body;
an upper body having a bottom end attached to a second end of the lower body, the upper body containing a high voltage circuit; and
a noble gas globe containing at least one noble gas, operatively connected to a top end of the upper body, the noble gas globe configured to produce a plasma discharge responsive to a user's touching of the noble gas globe.

2. The writing implement of claim 1, further comprising:
a low voltage power source operatively connected to the high voltage circuit.

3. The writing implement of claim 2, wherein the high voltage circuit is configured to convert an output of the low voltage power source to a high voltage output.

4. The writing implement of claim 3, further comprising:
a switch extending through an outer sidewall of the upper body operable to selectably connect the low voltage power source to the high voltage circuit.

5. The writing implement of claim 4, wherein the writing tip is in communication with an ink cartridge carrying a volume of ink.

6. The writing implement of claim 4, wherein the noble gas globe contains a plurality of noble gasses.

7. The writing implement of claim 4, wherein the high voltage circuit comprises:
an oscillator operatively connected to a flyback transformer.
